(19) United States
(12) Patent Application Publication
(10) Pub. No.: US 2025/0118982 A1
(43) Pub. Date: Apr. 10, 2025

(54) FLEXIBLE BATTERY MANAGEMENT SYSTEM (BMS)-GATEWAYS AND MODULAR ENERGY MANAGEMENT SYSTEMS FOR SECOND-LIFE ELECTRIC VEHICLE (EV) BATTERIES IN ENERGY STORAGE SYSTEMS

(71) Applicant: San Diego State University Research Foundation, San Diego, CA (US)

(72) Inventors: Chunting Chris Mi, San Diego, CA (US); Wei Gao, San Diego, CA (US)

(21) Appl. No.: 18/987,671

(22) Filed: Dec. 19, 2024

Related U.S. Application Data
(63) Continuation of application No. PCT/US2023/026755, filed on Jun. 30, 2023.
(60) Provisional application No. 63/358,759, filed on Jul. 6, 2022.
(60) Provisional application No. 63/376,027, filed on Sep. 16, 2022.

(51) Int. Cl. H02J 7/04; H01M 10/42; H01M 10/44; H02J 7/00

(52) U.S. Cl. CPC H02J 7/04; H01M 10/425; H01M 10/441; H02J 7/00032; H02J 7/00047; H02J 7/0013; H02J 7/0031; H02J 7/0047; H01M 2010/4271; H01M 2220/20

(57) ABSTRACT

Flexible battery management system (BMS)-gateways and modular energy management systems for second-life electric vehicle (EV) batteries in energy storage systems are disclosed. In one aspect, the system includes a plurality of EV battery packs, and a plurality of BMS-gateways each coupled to at least one of the EV battery packs. Each of the BMS-gateways is configured to communicate with the at least one EV battery pack via a communication protocol. The system also includes a modular energy management system (MEMS) configured to control the EV battery packs via the BMS-gateways.

### CROSS-REFERENCE TO RELATED APPLICATION(S)

This application is a continuation of International Application No. PCT/US2023/026755, filed Jun. 30, 2023, which is based upon and claims the benefit of U.S. Provisional Application No. 63/358,759, filed Jul. 6, 2022 and U.S. Provisional Application No. 63/376,027, filed Sep. 16, 2022. The foregoing applications are hereby incorporated by reference in their entireties.

### STATEMENT REGARDING STATE OF CALIFORNIA SPONSORED R&D

This invention was made with State of California support under California Energy Commission grant number EPC 19-053. The Energy Commission has certain rights to this invention.

### BACKGROUND

### Field

Embodiments of this disclosure relate to energy storage systems, and more particular, to the use of second-life electric vehicle (EV) batteries in energy storage systems.

### Description of the Related Technology

Electric vehicles (EVs) use batteries to store energy and provide power to an electric motor for propulsion. EV batteries typically have a defined lifespan during which the batteries can be safely used. After an EV battery has exceeded its lifespan, the battery is retired from use to ensure the safe operation of the EV. With the increasing penetration of EVs, the number of batteries retiring every year is expected to increase into the millions of battery packs.

### SUMMARY OF CERTAIN INVENTIVE ASPECTS

The innovations described in the claims each have several aspects, no single one of which is solely responsible for its desirable attributes. Without limiting the scope of the claims, some prominent features of this disclosure will now be briefly described.

In a first aspect, a battery energy storage system is disclosed. The battery energy storage system may include, for example, a plurality of electric vehicle (EV) battery packs; a plurality of battery management system (BMS)-gateways each coupled to at least one of the EV battery packs, wherein each of the BMS-gateways is configured to communicate with the at least one EV battery pack via a communication protocol; and a modular energy management system (MEMS) configured to control the EV battery packs via the BMS-gateways.

In some embodiments, the EV battery packs are retired from use in electric vehicles. In some embodiments, the communication protocol is proprietary. In some embodiments, the each of the BMS-gateways is further configured to read one or more parameters from the at least one EV battery pack and provide the one or more parameters to the MEMS. In some embodiments, the each of the BMS-gateways is further configured to measure signals from the at least one EV battery pack. In some embodiments, the each of the BMS-gateways is further configured to provide the one or more parameters and the measured signals to the MEMS in real time. In some embodiments, the BMS-gateways are further configured to assign a unique identification to each of the EV battery packs. In some embodiments, the EV battery packs are installed into the battery energy storage system without being disassembled. In some embodiments, the EV battery packs are manufactured by a plurality of different original equipment manufacturers (OEMs) and the BMS-gateways are further configured to support the EV battery packs from the different OEMs. In some embodiments, the system further includes an inverter connecting the EV battery packs to an electrical grid. In some embodiments, the MEMS is configured to implement a model-based predict control (MPC) configured to collect one or more parameters relating to the EV battery packs from the BMS-gateways, and determine power flow of the system based on the collected parameters. In some embodiments, the MEMS is configured to execute pack-level control of the EV battery packs based on the determined power flow, and distribute power to each of the EV battery packs based on the collected parameters corresponding to each of the EV battery packs. In some embodiments, the MEMS is configured to detect an abnormal situation based on the collected parameters, and shut down the system in response to detecting the abnormal situation.

In a second aspect, a method of controlling a battery energy storage system is disclosed. The method may include, for example, communicating, using each of a plurality of battery management system (BMS)-gateways, with a corresponding one of a plurality of electric vehicle (EV) battery packs via a communication protocol; and controlling, using a modular energy management system (MEMS), the EV battery packs via the BMS-gateways.

In some embodiments, the method further includes installing the EV battery packs into the battery energy storage system after the EV battery packs are retired from use in electric vehicles. In some embodiments, the communication protocol is proprietary. In some embodiments, the method further includes reading, using each of the BMS-gateways, one or more parameters from the corresponding EV battery pack, and providing, using each of the BMS-gateways, the one or more parameters to the MEMS. In some embodiments, the method further includes measuring, using each of the BMS-gateways, signals from the corresponding EV battery pack. In some embodiments, the method further includes providing, using each of the BMS-gateways, the one or more parameters and the measured signals to the MEMS in real time. In some embodiments, the method further includes assigning, using each of the BMS-gateways, a unique identification to the corresponding EV battery pack.

### BRIEF DESCRIPTION OF THE DRAWINGS

FIG. 1A provides a view of an electric vehicle (EV) battery in accordance with aspects of this disclosure.

FIG. 1B illustrates an example technique for reusing EV batteries for second-life applications in accordance with aspects of this disclosure.

FIG. 2 illustrates an energy storage system including an EV battery pack, the BMS-gateway, and the modular energy management system according to aspects of this disclosure.

FIG. 3 illustrates an example energy storage system connected to the power grid in accordance with aspects of this disclosure.

FIG. 4 illustrates the architecture of a centralized modular energy management system (MEMS) in accordance with aspects of this disclosure.

FIG. 5 illustrates a hardware connection in a sample system.

FIG. 6 illustrates an example embodiment of a BMS-gateway in accordance with aspects of this disclosure.

FIG. 7 illustrates one embodiment of the MEMS hardware with a desktop as the main control hardware in accordance with aspects of this disclosure.

FIG. 8 is a block diagram illustrating the MEMS software in accordance with aspects of this disclosure.

FIGS. 9A-9D illustrate the functionality of the MEMS software blocks of FIG. 8 in accordance with aspects of this disclosure.

### DETAILED DESCRIPTION

### Introduction to Second-Life Electric Vehicle (EV) Batteries

With the increasing penetration of electric vehicles (EVs), millions of battery packs are expected to retire every year. After EV batteries are no longer suitable for vehicle use, EV batteries can still operate reliably in stationary energy storage applications and provide grid resiliency. Additionally, the availability of economically competitive and reliable energy storage is one of the largest barriers to expand the increasing use of renewables in the electrical grid. Thus, it is desirable to use retired EV batteries for “second-life” applications such as energy storage in the electrical grid, for example, within a battery energy storage system (BESS). Accordingly, the adoption of renewable energy can be increased by providing a cost-effective and reliable technique for incorporating second-life EV batteries into a BESS.

There are at least two approaches for reusing second-life EV battery packs in an energy storage system: using the original EV battery packs and disassembling the EV battery packs to obtain modules and/or cells.

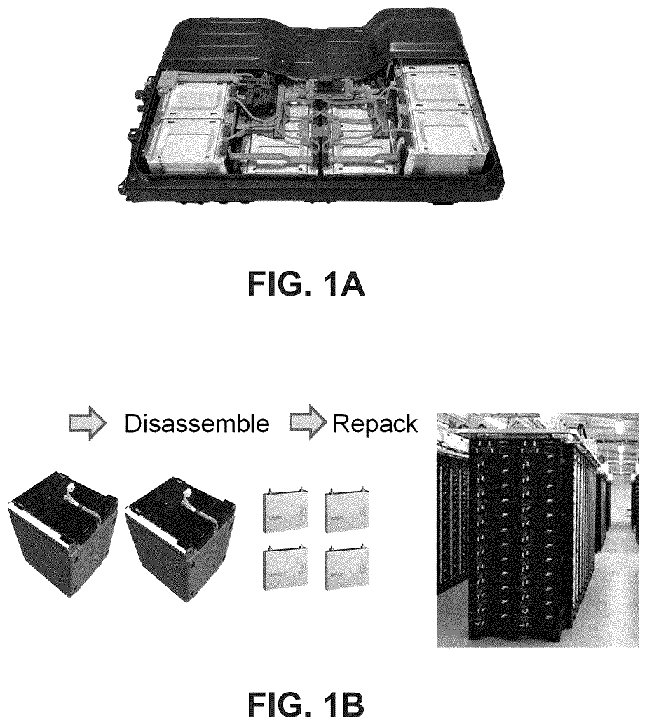

FIG. 1A provides a view of an electric vehicle (EV) battery in accordance with aspects of this disclosure. The EV battery is shown with the cover partially removed to illustrate certain internal components including the individual modules and/or cells that make up the EV battery.

FIG. 1B illustrates an example technique for reusing EV batteries for second-life applications in accordance with aspects of this disclosure. In particular, FIG. 1B illustrates a process of disassembling an EV battery to obtain modules and/or cells and repacking the modules and/or cells for use in an energy storage system.

However, it can be costly in terms of manpower, economics, and/or safety to disassemble and repack the EV batteries. These costs may be so high as to make the disassembly and repacking of the EV batteries infeasible. Compared to disassembling the battery packs to obtain modules and/or cells, using the original packs is more economically feasible because it saves the manpower and/or costs associated with the disassembly and regrouping of the batteries. Thus, it is desirable to provide systems and techniques which can reuse retired EV batteries for second-life applications without requiring disassembly and/or regrouping of EV batteries.

### BMS-Gateway and Modular Energy Management System (MEMS) for Second-Life EV Batteries

There may be certain challenges associated with reusing the whole EV battery pack as is. For example, when using the whole EV battery pack, battery cell information e.g., cell voltages, temperatures, current, etc. may not be accessible due to the original equipment manufacturer (OEM) including a proprietary battery management system (BMS) in the EV battery pack. That is, when the EV battery pack is not opened, the onboard battery management system (BMS) may be the only source that can provide battery cell information including the measure cell voltages and temperatures. However, the OEM does not typically provide access to the communication protocol(s) used to access the battery cell information from the onboard BMS. Therefore, it may not be possible to manage the EV battery packs using only the existing onboard BMS.

Another challenge is that the OEM communication protocol can be identical for each EV battery pack from the same OEM. Thus, when a plurality of EV battery packs from the same OEM are connected to the same main controller, the main controller may not be able to distinguish the information received from the onboard BMSs of the EV battery packs because the EV battery packs may share the same message ID.

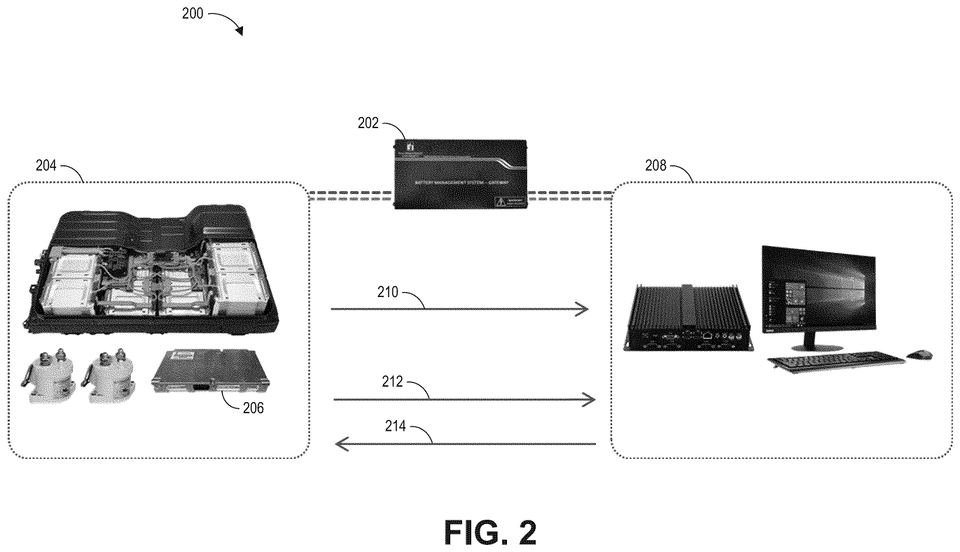

Aspects of this disclosure relate to a BMS-Gateway and a modular energy management system (also referred to as an “energy management system”) that can address at least some of the above-described challenges. FIG. 2 illustrates an energy storage system 200 including an EV battery pack, the BMS-gateway, and the modular energy management system according to aspects of this disclosure.

As shown in FIG. 2, the BMS-gateway 202 acts as an intermediary between the EV battery pack 204 and the modular energy management system 208. The EV battery pack 204 can also include an onboard-BMS 206 configured to control the individual battery cell(s) with the EV battery pack 204. The BMS-gateway 202 can be configured to read battery information from the onboard-BMS 206 of the EV battery pack 204 and communicate the information to the modular energy management system 208. For example, the BMS-gateway 202 can be configured to read parameters of the EV battery pack 204 from the onboard-BMS 206 including, for example, battery parameters 210 such as battery cell voltage(s), DC voltage, current, and/or temperatures. The BMS-gateway 202 may also be configured to estimate or derive certain parameters 212 such as the state-of-charge (SOC), state-of-health (SOH), battery balance algorithm, protection algorithm based on the battery parameters 210. Using the information obtained from the BMS-gateway 202, the modular energy management system 208 can generate control signals 214 for controlling the charging/discharging of the EV battery pack 204 and provide the control signals to the EV battery pack 204 via the BMS-gateway 202. By incorporating the modular energy management system 208, the energy storage system 200 can implement a fully functional battery pack with all of the information, protection, and control of an originally manufactured energy storage system.

In certain embodiments, when constructing a BESS the retired EV battery packs 204 can be considered as a black box with no data and no control. For example, due to the use of proprietary BMSs, the retired EV battery packs 204 may not provide any data or be controllable without using the OEM's proprietary communication protocols. By using the BMS-gateway 202 as an intermediary to the EV battery packs 204, the modular energy management system 208 can interact with the BMS-gateway 202 in a manner similar to interacting with a fully functional battery pack with all the data, protection, and control needed for second-life use. In some implementations, the BMS-gateway 202 can appear the same as or similar to a repacked battery pack as shown in FIG. 1B.

Depending on the implementation, the BMS-gateway 202 can be configured communicate with the onboard BMS 206 of an EV battery pack 204 by cracking the communication protocol to achieve the battery cell voltages, temperatures, current, etc. The BMS-gateway 202 can also be configured to measure signals that the onboard BMS 206 does not or cannot provide, such as the DC-link voltage, current, and high voltage insulation, etc. In some embodiments, the BMS-gateway 202 further include built-in algorithm(s) configured to estimate battery state of charge (SOC), state of health (SOH), and/or to perform battery balance and protection. The BMS-gateway 202 can send of the collected and generated data to the energy management system 208 in real time to enable higher level management. The BMS-gateway 202 can also assign a unique ID for each EV battery pack 204 so that the energy management system 208 can monitor and control each EV battery pack 204 individually.

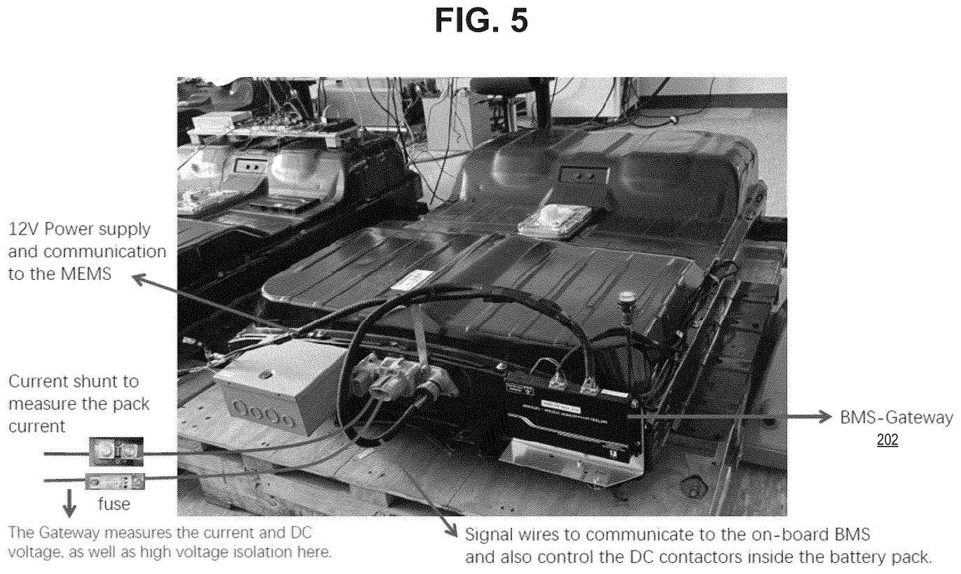

In some embodiments, there is at least one internal onboard manufacturer BMS inside of the EV battery pack 204 which gathers the cell-level data and sends them out using CANBUS messages with manufacturer-specific encoding. The BMS-gateway 202, after decoding (cracking) these messages, retrieves the data, reorganizes them, and sends them to the upper control using CANBUS messages with user-customized encoding. Therefore, for the cell-level data in this embodiment, the BMS-gateway 202 requires no extra hardware. Nonetheless, certain peripheral sensors can be added per user demand. These peripheral sensors would mainly gather pack-level lumped data such as total voltage and total current. The BMS-gateway 202 can also talk to these peripheral sensors using analog or digital I/O or ordinary communication protocols. FIG. 5 is provided to illustrate a sample hardware connection, as well as illustrating measure signals.

By using the BMS-gateway 202, the energy storage system 200 can directly use the EV battery pack 204 without needing to open and/or disassemble the EV battery pack 204. This can save time and costs, thereby making the reuse of EV battery packs 204 in energy storage systems 200 more economically feasible.

In certain embodiments, the BMS-gateway 202 can include hardware configured to support many different types of EV battery packs 204 (e.g., EV battery packs 204 from different OEMs). The BMS-gateway 202 can include built-in communication protocols to communicate to the onboard BMS 206 via a signal port on the onboard BMS 206.

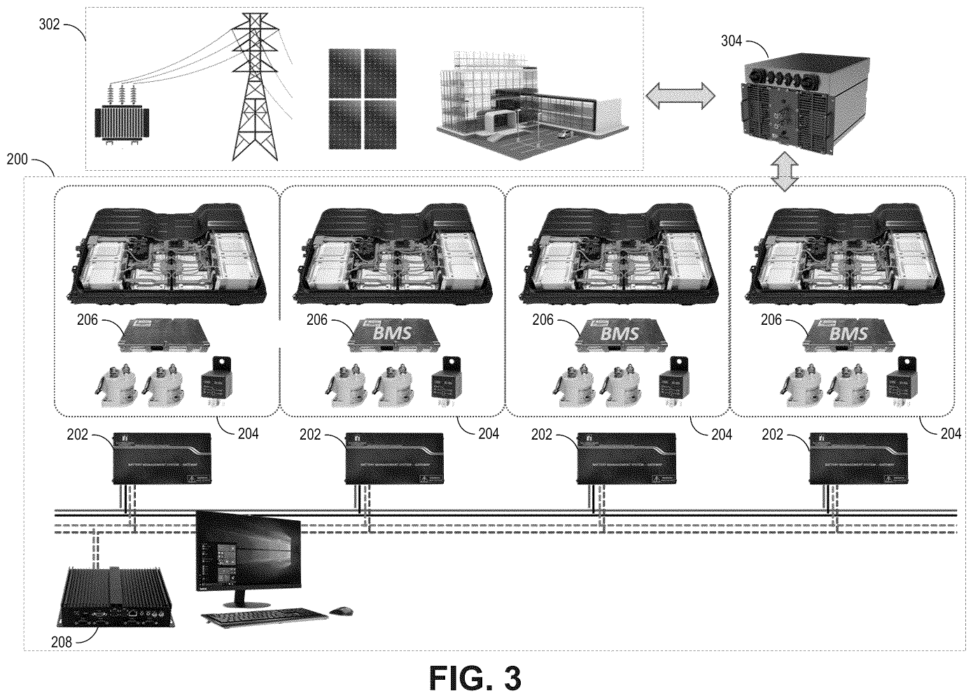

FIG. 3 illustrates an example energy storage system connected to the power grid 302 in accordance with aspects of this disclosure. With reference to FIG. 3, the energy storage system 200 is connected to the power grid 302 via an inverter/DCDC converter 304. The energy storage system 200 includes a plurality of EV battery packs 204 connected to the inverter/DCDC converter 304, a modular energy management system 208, and a plurality of BMS-gateways 202 connected between the modular energy management system 208 and the EV battery packs 204.

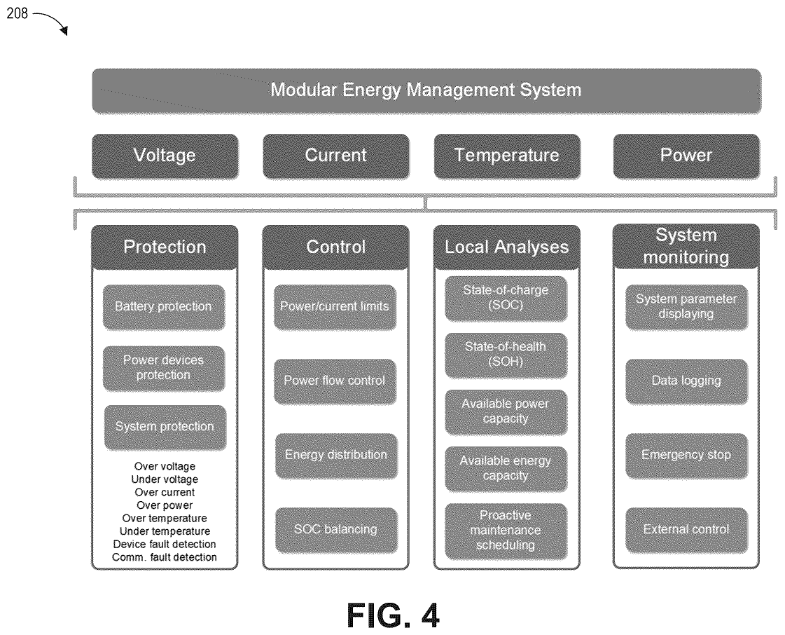

FIG. 4 illustrates the architecture of a centralized modular energy management system (MEMS) 208 in accordance with aspects of this disclosure. The modular energy management system 208 is configured to collect data from the BMS-Gateway 202 and perform a number of different functions using the collected data. For example, the MEMS 208 can be configured to perform one or more of the following: 1) reduce utility bills by optimizing the utilization of the BESS, 2) extend the life span of the second-life EV battery packs 204, 3) monitor and record the status of the BESS, and 4) provide protection to prevent potential hazards and protect the BESS.

In certain implementations, the MEMS 208 can be configured to implement an active and intelligent model-based predict control (MPC) in order to reduce utility bills. By executing the MPC, the MEMS 208 is configured to optimize or improve the utilization of the BESS. For example, the MEMS 208 can collect some or all of the information from the BMS-Gateway 202 and the existing system (including for example SOC, SOH, load power, and solar power) and determine the power flow of the BESS based on the collected information to maximize or improve the benefits of the system.

After the MPC has determined the power flow, the MEMS 208 can execute pack-level control and distribute power to each of the EV battery packs 204 in the BESS based on one or more of the corresponding parameters (e.g., SOC, SOH, maximum available power, etc.). By employing pack-level control, which allocates different power commands to each EV battery pack 204, the SOC of the EV battery packs 204 can be naturally balanced, while the lifespan of second-life EV batteries 204 can be extended at the same time. Moreover, the MEMS 208 can actively monitor the system status, including power level, voltage, current, temperature, and so on, to ensure a stable operation. Once an abnormal situation is detected, the MEMS 208 can shut down the BESS to protect the devices and prevent potential hazards. Finally, the MEMS 208 can further include a concise but informative user interface enabling users to monitor and, to some degree, control the system.

With reference to FIG. 4, the MEMS 208 can receive parameters (e.g., voltage, current, temperature, and/or power) for each of the EV battery packs 204 from the BMS-gateways 202. The MEMS 208 can be configured to perform a number of different functions/algorithms based on the received parameters. For example, the functions of the MEMS 208 may be divided into at least for categories including: protection, control, local analysis, and/or system monitoring.

The protection algorithm of the MEMS 208 may include different sub-algorithms, such as one or more of the following: battery protection, power devices protection, and system protection. The protection algorithms can be configured to protect the corresponding device(s) from one or more of the following conditions: over voltage, under voltage, over current, over power, over temperature, under temperature, device fault detection, and communication fault detection. The MEMS 208 may take different actions depending on the particular condition that the MEMS 208 determines a given device is at risk of experiencing or currently experiencing. The protection algorithm may provide information on the determined condition and corresponding device(s) to the control algorithm to address the condition.

The control algorithm of the MEMS 208 may include different sub-algorithms, such as one or more of the following: power/current limits, power flow control, energy distribution, and SOC balancing. The control sub-algorithms may be configured to control the EV battery packs 204 to meet the overall power and energy demands of the electrical grid 302 while also addressing any conditions identified by the protection algorithm.

The local analysis algorithm of the MEMS 208 may include different sub-algorithms, such as one or more of the following: SOC, SOH, available power capacity, available energy capacity, and proactive maintenance scheduling. In some embodiments, the control algorithm can be configured to use information generated by the local analysis algorithm to control the BESS. The MEMS 208 can also be configured to display at least some of the information determined by the local analysis algorithm to a user.

The system monitoring algorithm of the MEMS 208 may include different sub-algorithms, such as one or more of the following: system parameter displaying, data logging, emergency stop, and external control. The MEMS 208 can also be configured to display at least some of the logged information by the system monitoring algorithm to a user. The system monitoring algorithm may also be configured to receive input from the user, including whether to perform an emergency stop or other external controls for controlling the BESS.

### Example Embodiment of a BMS-Gateway

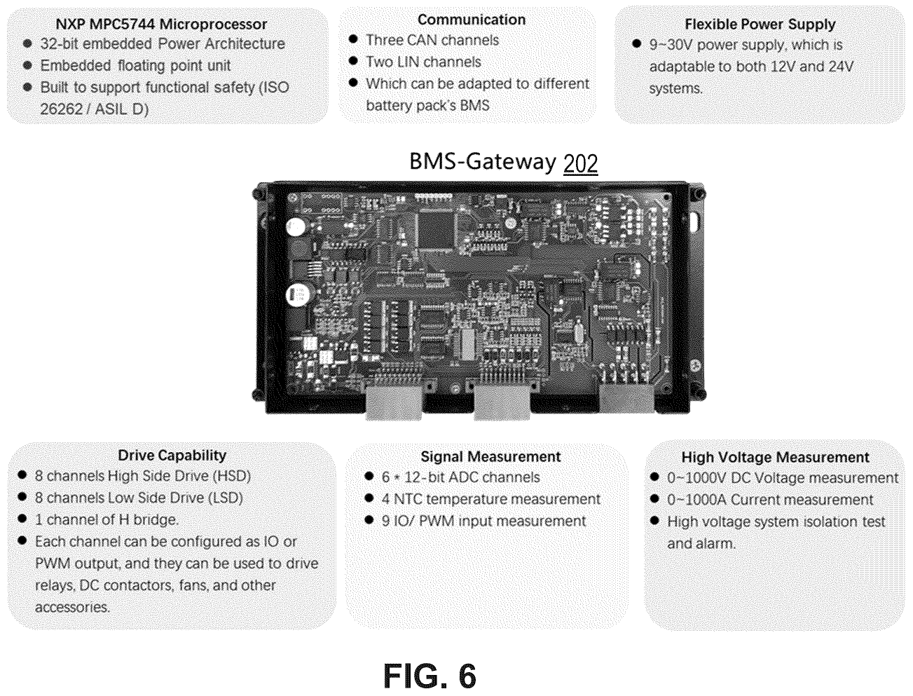

FIG. 6 illustrates an example embodiment of a BMS-gateway 202 in accordance with aspects of this disclosure. As shown in FIG. 6, the BMS-gateway 202 can be implemented as a controller hardware designed to works between the MEMS 208 and each EV battery pack 204 as a gateway. In some implementations, each retired EV battery pack 204 can be equipped with a corresponding BMS-gateway 202. The BMS-gateway 202 is configured to obtain certain battery data (e.g., metrics indicative of the current state/health of the battery). For example, the BMS-gateway 202 can obtain data such as battery cell voltages, temperatures, current, etc. from the onboard BMS 206 of the corresponding EV battery pack 204 through controller area network (CAN) or local interconnect network (LIN) communication. The BMS-gateway 202 is further configured to measure the EV battery pack's 204 voltage and current and control the EV battery pack's 204 relays and DC contactors. As described herein, the BMS-gateway 202 is configured to manage the retired EV battery packs 204 without opening the EV battery packs 204 or swapping the onboard BMS 206 of the EV battery packs 204. Consequently, using the BMS-gateways 202 saves time and cost to deploy retired EV battery packs 204 into energy storage systems 200.

FIG. 6 also illustrates the hardware layout of the example BMS-gateway 202. In particular, the illustrate BMS-gateway 202 includes three CAN channels, two LIN channels, an 8 channel high side drive (HSD), an 8 channel low side drive (LSD), 9 IO/PWM channels, 6 ADC channels, 4 NTC temperature measurement channels, DC voltage measurement channel(s), current measurement channel(s), a high voltage system isolation test and alarm, a microprocessor, and a power supply. CAN channels may be one of the most commonly used communication standards in vehicles.

One of the CAN channels can be used to communicate with the MEMS 208. The other CAN and LIN channels can be configured to communicate with the onboard BMS 206 or vehicle control unit (VCU) of the corresponding EV battery pack 204 to get the battery cell voltages and temperatures. The BMS-gateway 202 can also be configured to provide general control and measurement functions. For example, the 8 channels HSD and LSD can be configured to control the relays, DC contactors, fans, pumps, cooling, and/or heating systems, etc. of the corresponding EV battery pack 204. The BMS-gateway 202 can also be configured to provide general measurement functions via the 9 IO/PWM, 6 ADC, and 4 NTC temperature measurement channels. The BMS-Gateway 202 can further be configured to measure the DC voltage and current of the corresponding EV battery pack 204 as well as detect the high voltage isolation to the EV battery pack 204 shell.

The BMS-gateway's 202 hardware is versatile and is configured to be adapted to many different commercial EV battery packs 204. However, different EV battery packs 204 may have different communication protocols. For example, an EV battery pack 204 may use proprietary communication protocol which can be either provided by the OEM or cracked by studying the communication process. Many BMS communication protocols are not encrypted, and therefore can be cracked.

The BMS-gateway 202 is configured to continuously communicate with the onboard BMS 206 of the corresponding EV battery pack 204 and measure the signals described above. Thus, all or substantially all of the EV battery pack's 204 data can be sent to the MEMS 208 periodically, e.g., once a second by the BMS-gateway 202, or at other frequencies and/or at irregular intervals.

### Example Embodiments of a MEMS System

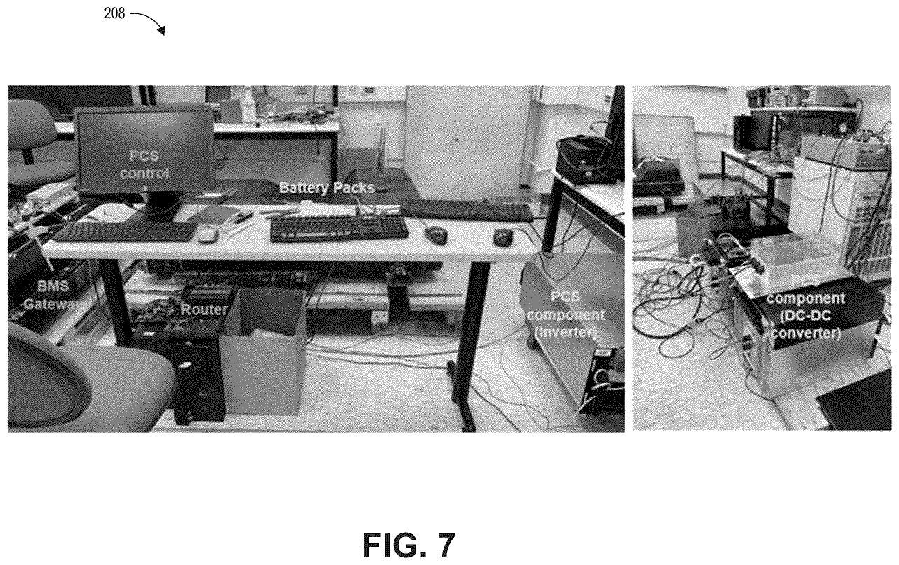

There are multiple possible embodiments for the MEMS 208 hardware. One example embodiment is a desktop/laptop with basic I/O peripherals such as screen and keyboard/mouse. Another example embodiment is a microprocessor-based embedded controller with graphic interface, such that the user can interact with the system. FIG. 7 illustrates one embodiment of the MEMS 208 hardware with a desktop as the main control hardware in accordance with aspects of this disclosure.

The MEMS 208 hardware includes a plurality of communication interfaces configured to communicate with the BMS-gateway 202 and components of the power control system (PCS). In certain embodiments, the MEMS 208 hardware is configured to be connected to the BMS-gateway 202 through a CAN bus and to the components in the PCS through a router and Ethernet cables.

The MEMS 208 software running on the MEMS 208 hardware can be configured to implement a comprehensive BESS management software. The MEMS 208 software can be developed to be run on the MEMS 208 hardware and can be configured to cause the MEMS 208 hardware to interact with each of the BMS-gateway 202/EV battery pack 204 combinations and with each component of the PCS using the corresponding communication protocols. In the embodiment shown in FIG. 7, the MEMS 208 software is configured to cause the MEMS 208 hardware to communicate with each of the BMS-gateways 202 using CAN protocol and with the PCS components using Modbus TCP protocol.

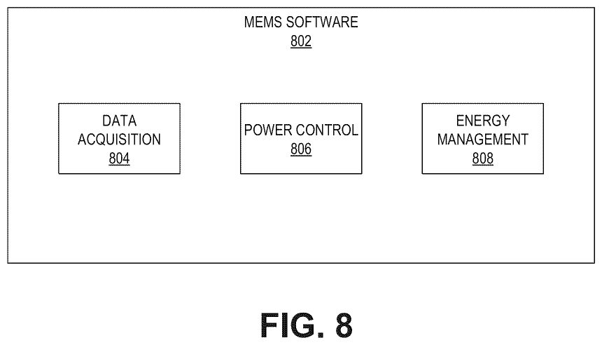

FIG. 8 is a block diagram illustrating the MEMS software 802 in accordance with aspects of this disclosure. The MEMS software 802 may be configured to implement at least three functions via respective blocks: data acquisition 804, power control 806, and energy management 808. The data acquisition 804 block can be configured to gather system data such as battery condition and real-time power and visualizes the data on a group of user interfaces. The MEMS software 802 can be configured to allow a user to access the data on various graphical user interface pages. The data acquisition 804 block can be configured to record the above data, together with optional extra system data, and upload part or all of the recorded data to a cloud repository on a regular basis. The power control 806 block can be implemented with a firmware-like set of programs which are configured to command and coordinate each of the BMS-gateway 202/EV battery pack 204 modules as well as each of the components of the PCS so that on-demand power control of each EV battery pack 204 can be realized. The power control 806 block can also be configured to perform real-time monitoring and fault-handling of each PCS component so that the system can be maintained online to the highest possible degree even in the face of exceptions and local failures. The energy management 808 block can be configured to provide an optimization routine which analyzes the real-time and historical battery condition data and the system power profile and accordingly determines and delivers the best power demand for each EV battery pack 204, such that the overall lifetime of the energy storage system 200 can be maximized while the user utility bill minimized.

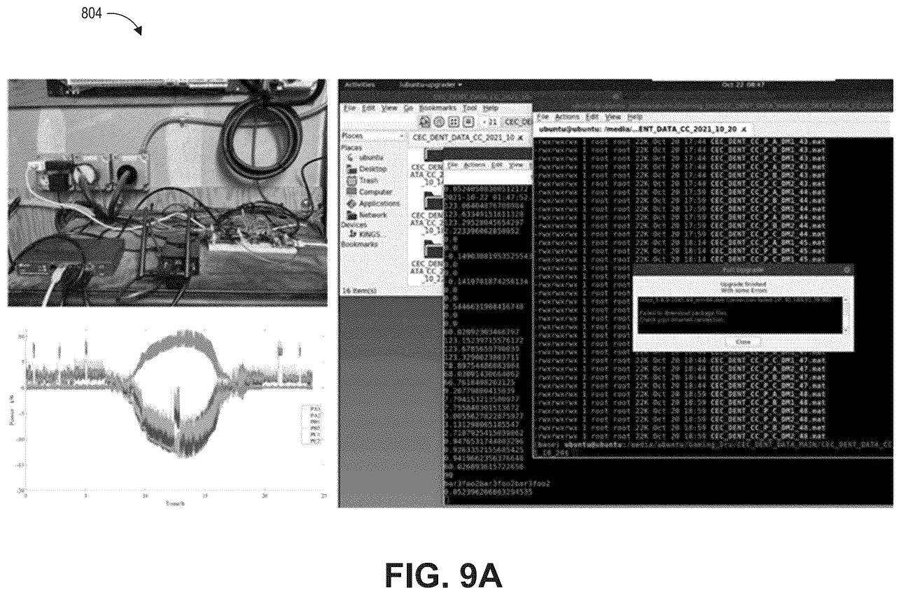

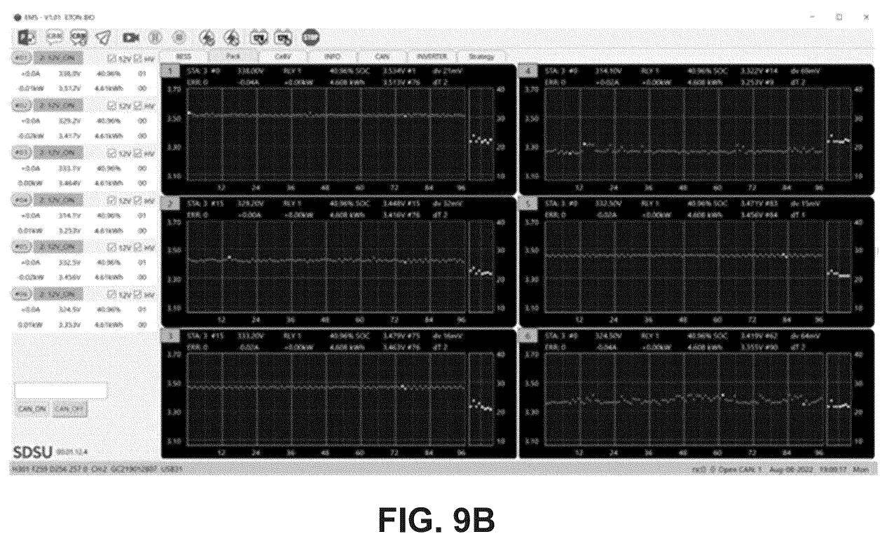

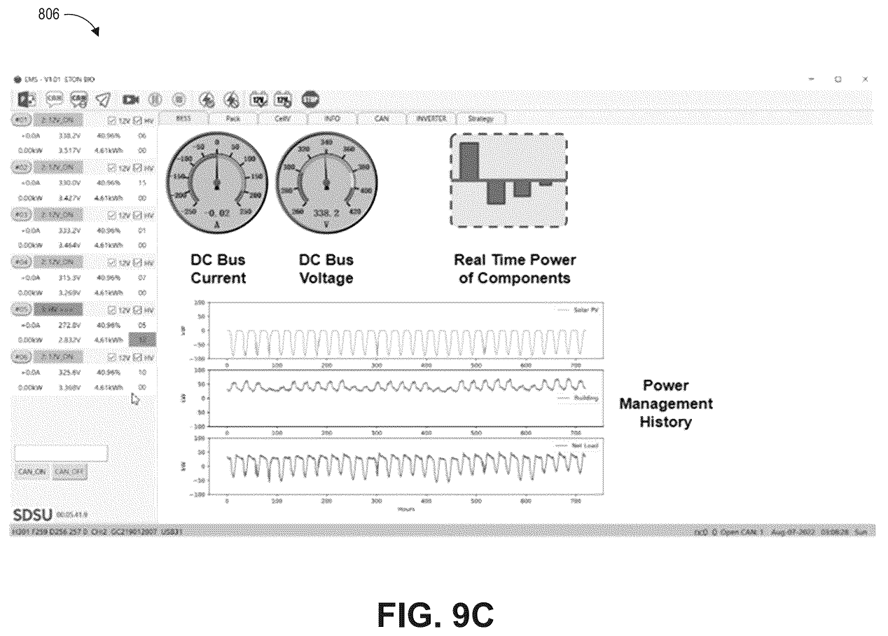

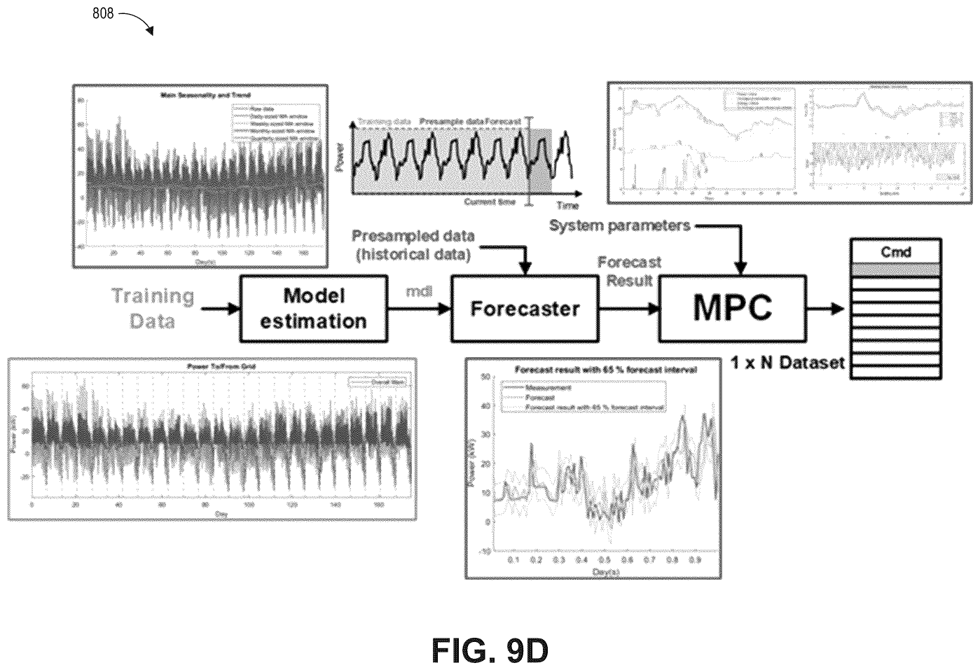

FIGS. 9A-9D illustrate the functionality of the MEMS software 802 blocks of FIG. 8 in accordance with aspects of this disclosure. In particular, FIG. 9A illustrates data acquisition 804 under the hood, FIG. 9B provides battery condition data visualization, FIG. 9C illustrates an overall system power condition information page which may result from the power control 806 algorithm, and FIG. 9D illustrates an energy management 808 algorithm under the hood.

Methods described herein may be implemented as software and executed by a general purpose computer. For example, such a general purpose computer may include a control unit/controller or central processing unit (“CPU”), coupled with memory, EPROM, and control hardware. The CPU may be a programmable processor configured to control the operation of the computer and its components. For example, CPU may be a microcontroller (“MCU”), a general purpose hardware processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor can be a microprocessor, but in the alternative, the processor can be any processor, controller, or microcontroller. A processor can also be implemented as a combination of computing devices, for example, a combination of a DSP and a microprocessor, a plurality of microprocessors, one or more microprocessors in conjunction with a DSP core, or any other such configuration. Such operations, for example, may be stored and/or executed by an onsite or remote memory.

While not specifically shown, the general computer may include additional hardware and software typical of computer systems (e.g., power, cooling, operating system) is desired. In other implementations, different configurations of a computer can be used (e.g., different bus or storage configurations or a multi-processor configuration). Some implementations include one or more computer programs executed by a programmable processor or computer. In general, each computer may include one or more processors, one or more data-storage components (e.g., volatile or non-volatile memory modules and persistent optical and magnetic storage devices, such as hard and floppy disk drives, CDROM drives, and magnetic tape drives), one or more input devices (e.g., mice and keyboards), and one or more output devices (e.g., display consoles and printers).

While the invention has been described in terms of several embodiments, those skilled in the art will recognize that the invention is not limited to the embodiments described, can be practiced with modification and alteration within the spirit and scope of the appended claims. In particular, the disclosure can be modified in terms of hardware and materials used to form the apparatus described herein. Any conventional or otherwise known materials could be implemented with the scope of the present disclosure. The description is thus to be regarded as illustrative instead of limiting.

What is claimed is:

1. A battery energy storage system, comprising:
a plurality of electric vehicle (EV) battery packs;
a plurality of battery management system (BMS)-gateways each coupled to at least one of the EV battery packs, wherein each of the BMS-gateways is configured to communicate with the at least one EV battery pack via a communication protocol; and
a modular energy management system (MEMS) configured to control the EV battery packs via the BMS-gateways.

2. The system of claim 1, wherein the EV battery packs are retired from use in electric vehicles.

3. The system of claim 1, wherein the communication protocol is proprietary.

4. The system of claim 1, wherein each of the BMS-gateways is further configured to read one or more parameters from the at least one EV battery pack and provide the one or more parameters to the MEMS.

5. The system of claim 4, wherein each of the BMS-gateways is further configured to measure signals from the at least one EV battery pack.

6. The system of claim 5, wherein each of the BMS-gateways is further configured to provide the one or more parameters and the measured signals to the MEMS in real time.

7. The system of claim 1, wherein the BMS-gateways are further configured to assign a unique identification to each of the EV battery packs.

8. The system of claims 1, wherein the EV battery packs are installed into the battery energy storage system without being disassembled.

9. The system of claim 1, wherein the EV battery packs are manufactured by a plurality of different original equipment manufacturers (OEMs) and the BMS-gateways are further configured to support the EV battery packs from the different OEMs.

10. The system of claim 1, further comprising:
an inverter connecting the EV battery packs to an electrical grid.

11. The system of Claims through 10, wherein the MEMS is configured to implement a model-based predict control (MPC) configured to:
collect one or more parameters relating to the EV battery packs from the BMS-gateways, and
determine power flow of the system based on the collected parameters.

12. The system of claim 11, wherein the MEMS is configured to:
execute pack-level control of the EV battery packs based on the determined power flow, and
distribute power to each of the EV battery packs based on the collected parameters corresponding to each of the EV battery packs.

13. The system of claim 11, wherein the MEMS is configured to:
detect an abnormal situation based on the collected parameters, and
shut down the system in response to detecting the abnormal situation.

14. A method of controlling a battery energy storage system, comprising:
communicating, using each of a plurality of battery management system (BMS)-gateways, with a corresponding one of a plurality of electric vehicle (EV) battery packs via a communication protocol; and
controlling, using a modular energy management system (MEMS), the EV battery packs via the BMS-gateways.

15. The method of claim 14, further comprising:
installing the EV battery packs into the battery energy storage system after the EV battery packs are retired from use in electric vehicles.

16. The method of claim 14, wherein the communication protocol is proprietary.

17. The method of claim 14, further comprising:
reading, using each of the BMS-gateways, one or more parameters from the corresponding EV battery pack, and
providing, using each of the BMS-gateways, the one or more parameters to the MEMS.

18. The method of claim 17, further comprising:
measuring, using each of the BMS-gateways, signals from the corresponding EV battery pack.

19. The method of claim 18, further comprising:
providing, using each of the BMS-gateways, the one or more parameters and the measured signals to the MEMS in real time.

20. The method of claim 14, further comprising:
assigning, using each of the BMS-gateways, a unique identification to the corresponding EV battery pack.
